(19) United States
(12) Patent Application Publication
(10) Pub. No.: US 2026/0105118 A1
(43) Pub. Date: Apr. 16, 2026

(54) DYNAMIC TRAFFIC ALLOCATION USING MACHINE LEARNING

(71) Applicant: Webflow, Inc., San Francisco, CA (US)

(72) Inventors: Jin Lim, Cupertino, CA (US); Wuyang Dai, Menlo Park, CA (US); Brian Webb, Los Gatos, CA (US); Guy Yalif, Burlingame, CA (US); Jason Kahn, Washington, DC (US)

(21) Appl. No.: 19/357,890

(22) Filed: Oct. 14, 2025

Related U.S. Application Data
(60) Provisional application No. 63/707,167, filed on Oct. 14, 2024.
(60) Provisional application No. 63/707,158, filed on Oct. 14, 2024.

(51) Int. Cl. G06F 16/958; G06F 16/957

(52) U.S. Cl. CPC G06F 16/958; G06F 16/9574

(57) ABSTRACT

Methods, systems, and apparatus, including computer programs encoded on computer storage media, for dynamically managing webpage traffic. In some implementations, a server receives a request from a client device to access a webpage. The server obtains attributes associated with the client device that provided the request. The server selects one or more webpage variants using the request. Data associated with the request and with the one or more webpage variants are provided as input to a trained machine learning model. The server obtains output from the machine learning model that indicates the likelihood for each webpage variant that the user will access a particular feature of the corresponding webpage variant. The server provides data representing the webpage variant of the one or more webpage variants whose likelihood satisfies a threshold value.

### CROSS-REFERENCE TO RELATED APPLICATIONS

This application claims the benefit of U.S. Provisional Application Nos. 63/707,158 and 63/707,167, each filed on Oct. 14, 2024, the contents of which are incorporated by reference in their entirety.

### TECHNICAL FIELD

This disclosure generally describes technology relating to machine learning, and more particularly, to technology related to the integration of machine learning to cloud-based software platforms.

### BACKGROUND

Machine learning (ML) enables systems to learn from data and improve their performance without being explicitly programmed for every task. Rather following predefined rules, ML systems build models based on patterns found in large datasets. These models may then make predictions, classify data, or perform decision-making tasks based on new, unseen data. ML may involve providing input data into a trained model, which processes the provided data to identify patterns or relationships within the data.

Machine learning may involve several types of learning. For example, in supervised learning, a model is trained on labeled data, where both the inputs and desired outputs are known. The goal is to learn a mapping from inputs to outputs to make predictions on new, unlabeled data. As another example, in unsupervised learning, a model works with data that has no labeled outcomes. Another example is reinforcement learning, where a model learns by interacting with an environment and receiving feedback in the form of rewards or penalties. ML has applications across industries, including healthcare, finance, and consumer-focused technologies. In the context of healthcare, ML systems and techniques may be useful to predict diseases, analyze medical images, and provide other advantages.

Typically, website owners seek to increase user interaction with their websites. Some of these approaches include applying split testing, which involves comparing different versions of a webpage to determine which version performs better in terms of user engagement and conversion rates. These approaches may have certain complications, such as shifting traffic and privacy constraints, each of which may impact reliable selection of a webpage for a particular website to meet desired user engagement and/or conversion objectives.

### SUMMARY

This disclosure relates to systems and techniques that use ML techniques to address problems that arise in computer-centered delivery and rendering pipelines. For example, the systems may determine, at request time, a webpage variant to present to a user based on a target goal. The systems also obtain attributes associated with the user and the corresponding client device (including historical requests), retrieve candidate webpage variants and applicable engagement or conversion goals, and provide features derived from these inputs. This includes descriptors or embeddings of user attributes, device attributes, goal metrics, and the webpage variants. These features are provided to one or more trained ML models configured to output, for each variant, a likelihood that the user will perform a specified action (e.g., selecting a GUI button, transitioning pages, or scrolling). Using thresholding or ranking, the system selects a webpage variant whose likelihood satisfies a threshold value and generates GUI data for the selected variant for display on the client device.

In certain implementations, operations the systems execute within an authoring and publishing environment in which a build pipeline compiles assets, writes build artifacts to an artifact repository, validates generated markup against a CMS schema, updates only affected bundles (including regenerating only affected locale bundles), and publishes changes through an edge delivery layer. This reduces unnecessary network transfers and client-side processing by returning only the selected variant's resources and reducing server-side processing by avoiding static iteration over all variants. In contrast with static A/B testing that fixes traffic allocations for extended periods and does not personalize on a per-request basis, the disclosed techniques dynamically route traffic among webpage variants according to predicted likelihoods and observed goal attainment over time. In some implementations, a trained ML model is selected from a set according to user-identified attributes with customer model isolation (preserving a common input/output interface while avoiding mixing of training data across customers). Collectively, these mechanisms improve computer operation in distributed web systems by optimizing resource movement and compute work across the build, validation, and delivery layers while supplying the client with a single, predicted-to-succeed variant for immediate rendering.

To accurately predict the webpage variant that leads to the target goal, the systems may generate various inputs to provide to the trained machine learning model. For example, a system may obtain various attributes associated with the user and the corresponding client device of the user. In this example, the system obtains attributes of the user, attributes of the corresponding client that device submitted the request, and one or more historical requests submitted by the user. Based on the obtained attributes, the system retrieves various webpage variants and one or more applicable engagement or conversion goals associated with the webpage variants. The system provides, as input, features derived from the obtained attributes, the webpage candidate variants, the one or more user engagement or conversion goals, and other data as input to a trained machine learning model. The trained machine learning model may process each of these inputs and output a likelihood for each webpage variant that the user will perform the action or user engagement or conversion goal data.

For example, a system may use thresholding techniques or ranking techniques to select amongst webpage variants in determining the webpage to present to a user. For example, the system may select the webpage variant whose likelihood satisfies a threshold value. In response to this selection, the system may generate GUI data associated with the selected webpage variant to provide to the client device for display. As a result, the GUI data that is provided to the client device corresponds to the webpage that is predicted to result in the user performing a specific action associated with that webpage.

In some implementations, the system may select, for a particular request, a trained machine learning model from a set of trained machine learning models according to user identified attributes. The system enforces customer model isolation, where each trained machine learning model of the set is trained from data corresponding to a particular customer or particular user. As a result, training data from different customers or different users is not mixed for a single machine learning model. Thus, attributes for a particular user are associate only with the corresponding machine learning model, which ultimately preserves data privacy for the system. Although the models are trained and utilized in isolation, the models preserve a common input and output interface. The common input and output interface ensures that any user attempting to interact with the system maintains continuity between models without having to change processes before performed when different models are selected.

Each model input may include descriptors, embeddings, or other identifiers of the user attributes, the device attributes, goal metrics, and the one or more webpage variants. As a result, the system may dynamically route traffic to different webpage variants according to the selections performed by the trained machine learning model. The system may increase traffic or decrease traffic to different webpage variants, and thus, route traffic to different webpage variants according to different goal attainment over time, exploration of different goals, feedback from the users, and other information.

In some implementations, these ML techniques operate within a broader Web Experience Platform (WEP) technique in order to improve various aspects of web development, such as automatic page generation, component refactoring, localization, and performance tuning within a comprehensive website development platform, such as the WEP. In the WEP, machine learning models (e.g., large language models (LLMs), large action models (LAMs)) may be trained and/or prompted using extensive datasets including versioned design snapshots, CMS collection content, component code libraries, build artifacts, and historical performance metrics. This data is leveraged during live authoring and runtime management sessions to generate new layout structures, translate content into additional languages, rewrite copy to meet accessibility guidelines, recommend edge caching strategies, and adjust build configurations for faster load times. By using these insights, the ML models enhance the experience of site controllers who design and maintain websites and of site users who access published pages. The integration of such ML models within the WEP also streamline backend operations by triggering incremental builds, updating database records, applying schema validations, and scheduling targeted cache invalidations without manual intervention. In this way, the incorporation of ML models improves not only the user experience delivered by the WEP but also optimizes the underlying technical infrastructure that stores data, compiles builds and serves content across the WEP.

The systems and techniques disclosed herein leverage ML to improve website development with varying levels of process automation. For example, a site controller may type a natural language request asking for a five-page marketing microsite, and a LLM may generate the corresponding page structures, themed style tokens, component markup, and placeholder media. The build pipeline then compiles these assets, writes them to the artifact repository, and publishes them through the edge delivery layer without the controller writing any code. As another example, when a site controller requests a redesigned testimonial slider, a ML model may query a content database to understand existing collection fields and reference links and then generates an updated component that preserves field binding relationships. The build system validates the generated markup against the CMS schema, updates only the affected bundle, and deploys the component so the new slider renders correctly across all locales without breaking any data driven pages.

In various implementations, the systems may use machine learning models to refine or extend existing websites after initial deployment. For example, a controller may prompt an assistant to translate all product collection items into Spanish and adjust the layout for right-to-left reading flows. The inference connector enriches the prompt with collection records from the content database, the language model returns translated strings and updated style rules, and the build system regenerates only the affected locale bundles, so the localized version appears online with minimal delay.

In one general aspect, a method is performed by a server. The method includes: receiving, by one or more processors, a request from a client device to access a webpage; obtaining, by the one or more processors, attributes associated with the client device that provided the request; selecting, by the one or more processors, one or more webpage variants using the request associated with the client device; providing, by the one or more processors, data associated with the request and data associated with the one or more webpage variants as input to a trained machine learning model, the trained machine learning model configured to output a likelihood that a user will select a particular feature on a webpage variant; obtaining, by the one or more processors, output from the trained machine learning model that indicates the likelihood for each webpage variant of the one or more webpage variants that the user will access a particular feature of the corresponding webpage variant; and providing, by the one or more processors and to the client device, data representing a webpage variant of the one or more webpage variants whose likelihood satisfies a threshold value.

Other implementations of this and other aspects of the disclosure include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The foregoing and other implementations can each optionally include one or more of the following features, alone or in combination. For example, some implementations include all the following features in combination.

In some implementations, obtaining attributes associated with the client device that provided the request includes: obtaining, by the one or more processors, user attributes associated with a user that interacts with the client device to provide the request; and obtaining, by the one or more processors, device attributes associated with the client device that provides the request.

In some implementations, the method further includes selecting, by the one or more processors, a trained machine learning model from a plurality of trained machine learning models using the user attributes associated with the user that interacts with the client device, where each trained machine learning model is associated with a different user.

In some implementations, selecting one or more webpage variants using the request associated with the client device includes: obtaining, by the one or more processors, an identifier of the webpage from the received request; and selecting, by the one or more processors, the one or more webpage variants using the obtained identifier of the webpage, where the one or more webpage variants include different graphical representations of the webpage in the request.

In some implementations, providing data associated with the request and data associated with the one or more webpage variants as input to a trained machine learning model includes: obtaining, by the one or more processors, inputs to provide to the trained machine learning model, where the inputs include user attributes associated with the user that provided the request, device attributes associated with the client device that submitted the request, a goal metric associated with the one or more selected webpage variants, and the one or more selected webpage variants; and providing, by the one or more processors, the obtained inputs to the trained machine learning model.

In some implementations, the trained machine learning model configured to output a likelihood that a user will select a particular feature on a webpage variant includes obtaining, by the one or more processors, the goal metric associated with each of the one or more selected webpage variants, where the goal metric includes a desired event for a user to perform on a webpage variant.

In some implementations, the goal metric associated with the one or more selected webpage variants includes at least one of a selection a graphical user interface (GUI) button on the webpage, transitioning from the webpage to a subsequent webpage, or performing another action on the webpage.

In some implementations, obtaining output from the trained machine learning model that indicates the likelihood for each webpage variant of the one or more webpage variants that the user will access a particular feature of the corresponding webpage variant includes: obtaining, by the one or more processors, the likelihood for each webpage variant of the one or more webpage variants that the user will perform the desired event associated with the goal metric; comparing, by the one or more processors, the likelihood for each webpage variant of the one or more webpage variants to the threshold value; and selecting, by the one or more processors, the webpage variant whose likelihood satisfies the threshold value.

In some implementations, providing, by the one or more processors and to the client device, data representing the webpage variant of the one or more webpage variants whose likelihood satisfies a threshold value includes: generating, by the one or more processors, GUI data that represents the webpage variant whose likelihood satisfies the threshold value; and providing, by the one or more processors, the generated GUI data that represents the webpage variant to the client device for display.

In some implementations, providing, by the one or more processors and to the client device, data representing the webpage variant of the one or more webpage variants whose likelihood satisfies a threshold value includes dynamically adjusting traffic to the client device associated with the webpage variant according to one or more goal metrics.

Particular implementations of the subject matter described in this specification can be implemented so as to realize one or more of the following advantages. For example, the technology of this application allows a system to respond to user requests by providing a webpage variant predicted to achieve a target goal. The system may select a particular webpage variant according to various attributes in conjunction with the use of a machine learning model. In addition, the system can provide the webpage variant predicted to achieve the target goal while maintaining visual stability on the client device of the user during rendering to minimize any perceived delays on the user's end.

The details of one or more implementations of the disclosure are set forth in the accompanying drawings and the description below. Other features, objects, and advantages of the invention will be apparent from the description and drawings, and from the claims.

### BRIEF DESCRIPTION OF DRAWINGS

FIG. 1 illustrates an example of a technique for determining a webpage variant using machine learning.

FIG. 2 illustrates an example of a web experience platform (WEP) for enabling web development using one or more ML models.

FIG. 3 is a block diagram of a system for dynamically constructing a user journey graph to achieve a target objective.

FIG. 4 is a block diagram of various user interfaces that illustrate an anti-flicker system for rendering of webpage variations.

FIG. 5 is a flow chart illustrating an example method of determining a webpage variant using machine learning.

In the drawings, like reference numbers represent corresponding parts throughout.

### DETAILED DESCRIPTION

This disclosure describes the application of ML techniques to improve various aspects of web development, such predicting a webpage variant to provide to a user device to achieve a target goal or a target metric. For example, the system may obtain user and device attributes with information of various candidate webpages. The system may provide the ingested user and device attributes as input to a machine learning model, where the machine learning model predicts a likelihood for a desired action for each webpage variant. The system may provide the webpage variant to the user or client device that satisfies a threshold value. As a result, the system is configured to enhance a user's interaction with a particular webpage by selecting a webpage that the system predicts the user will perform a specific action without relying on static testing or manual selection of webpages. In some implementations, the system may dynamically route traffic to each webpage based on the preferences of the user and the selections by the user over time.

Some A/B testing techniques involve splitting traffic among multiple versions of a particular variable in order to evaluate the effectiveness of that variable. The particular variable may be, for example, an email, a web page, a product design, an application, and other devices. Such A/B testing techniques enable scientific approaches to marketing and design, and aids with understanding customers'preferences, which ultimately creates more effective approaches. However, these techniques also may require fixing traffic to particular users for an extended period of time to evaluate the effectiveness of that variable, and as a result, do not personalize the presentation of a variable to the user in response to an individual request.

In contrast, the techniques described herein improve static, one-size-fits-all allocation with a personalized, context aware system that dynamically selects variables, e.g., webpages, to provide to users according to their preferences and predicted likelihoods. The system continuously learns from users prefers to dynamically route traffic to different webpages. As a result, this reduces overall network transfers, client-side processing by returning only the predicted webpage variant's resources, and server-side processing by not statically iterating through each webpage. As a result, these approaches improve a computer operation while increasing goal attainment for interacting with particular webpages without having to perform length A/B testing experiments.

As described herein, “machine learning” refers to a class of computational techniques and models, including to neural networks, transformer-based architectures, generative artificial intelligence, decision trees, support vector machines, clustering algorithms, and statistical learning methods. These techniques and models enable a computer system to automatically learn patterns or representations from data and improve performance on a given task without being explicitly programmed with task-specific rules. Machine learning systems may operate in supervised, unsupervised, semi-supervised, reinforcement, or self-supervised learning paradigms, and may be designed to perform a wide range of tasks such as classification, prediction, generation, translation, anomaly detection, and optimization across various data modalities, including text, images, audio, video, and structured data.

As described herein, a “model” refers to a computational system, algorithm, or structured representation used with a machine learning system. Examples of models include machine learning models, neural networks, transformer-based architectures, generative models, reasoning models, agentic systems, probabilistic models, statistical models, or rule-based systems. Models may be designed to process input data and produce outputs, predictions, decisions, actions, representations, or generated content. Models may operate under various learning paradigms, including supervised, unsupervised, semi-supervised, reinforcement, or self-supervised learning, and may be configured to perform tasks such as classification, regression, recommendation, anomaly detection, generation, translation, summarization, planning, decision-making, or multi-step reasoning across a range of data modalities, including structured data, text, images, audio, video, and sensor data.

As described herein, a “tool” refers to a discrete, callable unit of functionality that is registered within a platform registry and made accessible to one or more subsystems of an application. A tool may encapsulate a particular software capability, module, or feature, and may be invoked directly by a user or indirectly by an orchestration engine, assistant subsystem, or agentic process. A tool may be defined by a metadata specification that describes its functional purpose, input parameters, output types, and access constraints. Such metadata may further include contextual invocation rules or skill-gating requirements that limit tool execution based on user roles, system state, or external conditions. A tool may also be executed within the host application or may trigger remote services, APIs, or external modules. For example, a tool may perform a data transformation, retrieve content from a content management system, initiate a machine learning inference, or apply an automation feature to a digital asset. Tools may be atomic (e.g., performing a single function) or composite (e.g., orchestrating multiple underlying functions).

As described herein, a “module” generally refers to a discrete, encapsulated software unit that implements a defined subset of functionality within a larger system. For example, a module may include executable code, data structures, and associated interfaces that collectively enable the module to perform one or more tasks, operations, or services. In some implementations, a module may expose an API or inter-process communication interfaces through which other system components (e.g., agents, tools, or orchestration engines) may invoke module functionality. The module may be configured for local execution within an application runtime or for remote execution via a distributed service environment.

As described herein, a “collection” generally refers to a structured data container defined within a content management system. A collection may include one or more fields specifying attribute types and constraints, where each field is configured to store content of a designated type (e.g., text, image, reference, or relational identifier). The collection may further define a schema for a class of content items and may be programmatically bound to presentation templates for automatic instantiation of one or more web pages or components.

As described herein, a “component” generally refers to a reusable design element or grouping of design elements within a visual design environment. A component may include structural markup (e.g., containers, text elements, media placeholders), style definitions (e.g., Cascading Style Sheets (CSS) class associations), and behavioral attributes (e.g., event listeners, animations). Components may be instantiated multiple times across different pages, with instances linked to a common definition such that modifications to the component definition propagate to each instance.

As described herein, a “schema” generally refers to a structured definition that specifies the organization, attributes, and relationships of data within a system. A schema may define one or more fields, each field associated with a data type (e.g., text, integer, media, or relational reference), a set of constraints (e.g., required, optional, uniqueness), and optionally a linkage to other schemas or data sources. The schema operates as a blueprint governing how data is stored, validated, and retrieved by the system. A schema may be represented in a machine-readable format (e.g., JavaScript Object Notation (JSON), Hypertext Transfer Protocol (XML), proprietary markup), enabling programmatic generation of data containers and enforcement of structural consistency across instances. At runtime, the system may validate input data against the schema to ensure compliance and may utilize the schema to automatically bind data values to As used herein, a “template” generally refers to a parameterized layout structure defining a presentation format for one or more data-driven pages. A template includes a set of design elements, placeholders, and binding definitions linking fields of a collection to corresponding elements of the layout. Upon execution of a publishing or rendering process, the template is programmatically combined with data from one or more collection items to generate fully populated output pages or views.

As used herein, “interactions” generally refer to declarative animation and behavior specifications that define dynamic changes to one or more elements of a rendered page in response to runtime events. An interaction may include a trigger definition identifying the initiating event, a set of target elements, and one or more animation or state-change operations to be applied to the target elements according to defined timing or sequencing parameters.

As used herein, a “trigger” generally refers to an event condition that initiates execution of an associated interaction or workflow. Triggers may include user-interface events (e.g., click, hover, scroll, page load) or system-generated events (e.g., content update, data submission). A trigger definition may specify the scope of the monitored condition and, upon detection of such condition, causes initiation of the corresponding action sequence.

As used herein, “logic” refers to a declarative workflow specification defining automated operations to be executed in response to system or user events. Logic may be represented as a sequence of interconnected nodes or steps, where each step specifies an action (e.g., data manipulation, API request, content update) and may include conditional branching, variable mapping, or external service integration. Logic is evaluated and executed by a backend workflow engine in response to event detection.

As described herein, an “agent” (or “ML agent”) generally refers to a software entity configured to operate autonomously or semi-autonomously within a computing environment by perceiving context, evaluating state, and executing one or more actions on behalf of a user or system. Agents may incorporate ML models (LLMs, LAMs), or other ML-based subsystems that enable adaptive behavior, natural language processing, decision-making, and dynamic invocation of system functionality.

Further, an “agentic” process or behavior generally refers to the autonomous or context-driven execution of actions by an agent, without requiring explicit step-by-step instructions from a user. For example, agentic functionality may include interpreting natural language or multimodal prompts based on processing input queries submitted by a user. In other examples, agentic functionality includes determining relevant goals or sub-tasks, invoking software capabilities (e.g., tools, functions, external services registered) within a platform registry, and sequencing or chaining such invocations until an objective is satisfied.

In some implementations, each webpage variant is a different version of the same underlying webpage. The webpage variants may differ in various manners. In some examples, the structure of the variants may relate to differences in layout grid, GUI element placement, number of sections, order of sections, and other type. In some examples, the component composition of the variants may relate to differences in various GUI elements used to interact with each page, such as sliders, clicks, and other interactive components. In some examples, the content of each variant may differ, such as the images, the video, or other media displayed for the particular webpage. In some examples, the schema of each of the variants may differ, such as a color theme, the typography, the font, and the spacing of each of the data fields and data values.

For example, the webpage may be related to selling a particular book, and each variant may include different versions of that webpage. The different variants may display the same product or book but differ in the following: (i) a long review of the book against a compact review of the book, (ii) a “Buy Now” button placed above the book illustration vs the “Buy Now” button placed below the book illustration, (iii) cover art of the book enlarged on the webpage or cover art of the book shown in a thumbnail, and (iv) differences in color schemes applied to the webpage. In some examples, the different webpage variants may operate on an entire webpage basis or differ in terms of component granularity. In some examples, each webpage variant may share a common webpage template and differ by the context of the selected components at pre-render or render time.

In some implementations, the system may learn relationships between variant characteristics and goal outcomes according to the context of the request. The machine learning model may encode relevant attributes to produce a likelihood that the particular user will perform an action on the corresponding webpage. Generally, some webpage layouts or structures may pique the interest of more users than others. For example, a contrasted color scheme may cause a user to be more interested in scrolling through the webpage. Whereas a highlighted button on a particular webpage may cause the user to select that button more likely than others due to their own curiosity. A machine learning model may analyze these interdependencies between a user's selection or action on a webpage to one or more characteristics of a webpage. Based on the analysis of the interdependencies, the machine learning model may be configured to predict or infer which webpage, according to its structure, content, or other, will result in the corresponding user performing a particular action on that webpage.

For example, the machine learning model may have learned over time that every time a highlighted GUI button is labeled with yellow coloring and is overlaid on a black background, the user tends to select that particular button. Accordingly, when the user sends a request to that system for the particular webpage, the system may determine that for the particular webpage, the developer's desired goal is for a user to select the particular button. As a result, the machine learning model will select the webpage variant that has the yellow coloring button overlaid on a black background rather than a black button overlaid on a yellow background, for example, because the model has learned overtime the preferences for that user. Other examples are also possible.

In some implementations, these predictions may be applied to users and multiple sites while providing and preserving user privacy. The system maintains a plurality of trained machine learning models, where each trained machine learning model of the plurality is associated with a particular user. The system built or trained each model using training data associated with the particular user. As a result, the system trains and develops each machine learning model in isolation, so that the machine learning model is only relevant towards that particular user. Cross training across different models is avoided and the user's privacy is preserved.

Similarly, the system ensures that each trained machine learning model exposes a common interface and output. For example, the common interface may include a set interface that enables the system to provide various data inputs related to the webpage variants and a data output related to a likelihood for each webpage variant that the user is likely to perform some corresponding action. This process will be further described below. Consequentially, the system may ensure that dynamic traffic is adjusted and routed towards the selected website in response to receiving and processing the request from the user. This ensures improved target goal attainment, personalizing the user experience, and ensuring that the target goal attainment and the personalized experience aligns with designer defined goals for the corresponding webpage.

As described herein, “machine learning” refers to a class of computational techniques and models, including to neural networks, transformer-based architectures, generative artificial intelligence, decision trees, support vector machines, clustering algorithms, and statistical learning methods. These techniques and models enable a computer system to automatically learn patterns or representations from data and improve performance on a given task without being explicitly programmed with task-specific rules. Machine learning systems may operate in supervised, unsupervised, semi-supervised, reinforcement, or self-supervised learning paradigms, and may be designed to perform a wide range of tasks such as classification, prediction, generation, translation, anomaly detection, and optimization across various data modalities, including text, images, audio, video, and structured data.

As described herein, a “model” refers to a computational system, algorithm, or structured representation used with a machine learning system. Examples of models include machine learning models, neural networks, transformer-based architectures, generative models, reasoning models, agentic systems, probabilistic models, statistical models, or rule-based systems. Models may be designed to process input data and produce outputs, predictions, decisions, actions, representations, or generated content. Models may operate under various learning paradigms, including supervised, unsupervised, semi-supervised, reinforcement, or self-supervised learning, and may be configured to perform tasks such as classification, regression, recommendation, anomaly detection, generation, translation, summarization, planning, decision-making, or multi-step reasoning across a range of data modalities, including structured data, text, images, audio, video, and sensor data.

As discussed in detail below, the machine learning techniques disclosed herein may be provided to augment, streamline, and/or improve various aspects of a web experience platform that allows users to perform various types of actions relating to website development (e.g., access, design, develop, build, access, manage, analyze). Through use of machine learning, the techniques disclosed herein may select and provide webpage variants to user on a per request basis to achieve a desired goal. For example, in a ML-enabled web experience platform, when a user requests a particular webpage, the system may resolve user and device attributes, obtain variants and likelihoods of performing the action on those variants, and returns GUI data to the client device for the variant whose likelihood satisfies the threshold value. Moreover, and as will be further described below, the system seeks to display the GUI data to the client device to avoid flicker.

Implementations of the present disclosure are described in further detail herein with reference to an example variable, such as webpages. In some implementations, the techniques described in this present disclosure are applicable to any variable, such as webpages, emails, a product design, or an application, to name some examples.

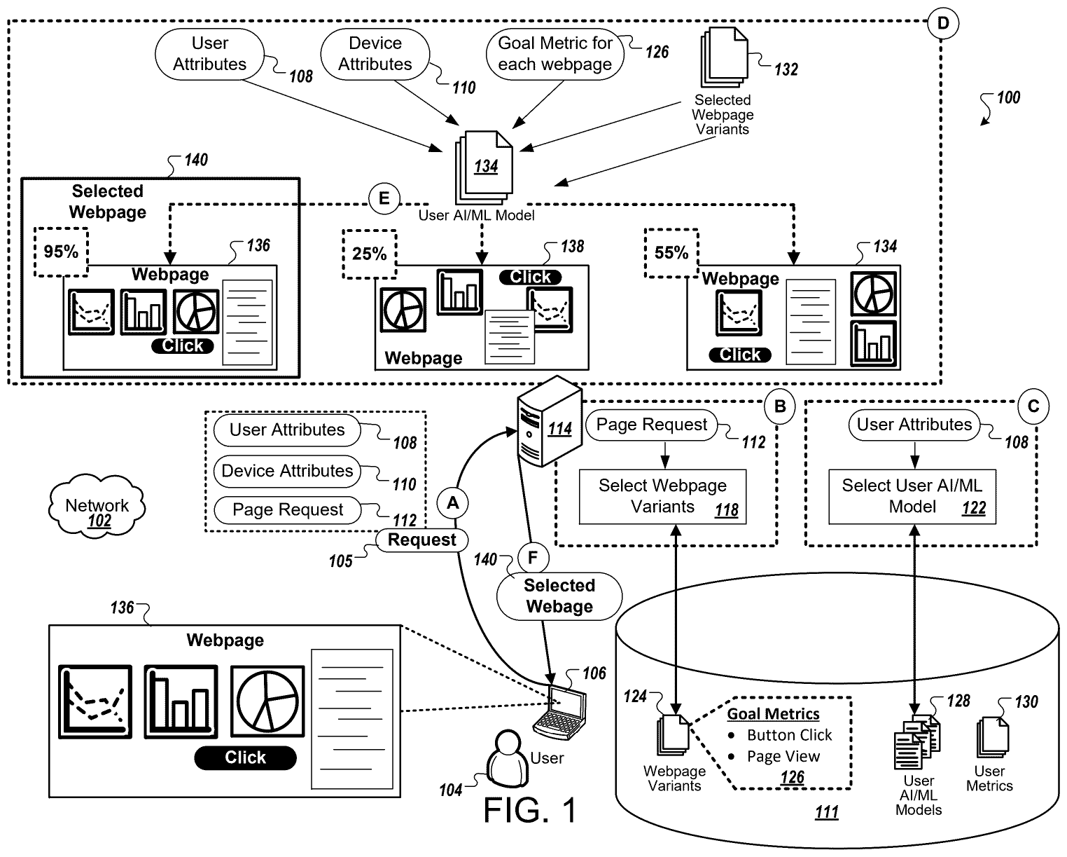

FIG. 1 is a block diagram of an example system 100 that performs techniques for determining a webpage variant using machine learning. The system 100 may include one or more servers or computers connected locally or over a network. The system 100 may include a network 102 that may be, for example, a local network, a Wi-Fi network, an intranet, an internet connection, or some other connection that enables the system 100 to communicate, e.g., transmit and receive, with various databases and one or more external devices. In some cases, the system 100 may include one or more databases. In some implementations, the system 100 may be performed by a cloud computing system over a network.

FIG. 1 illustrates various operations in stages (A) through (F), which may be performed in the sequence indicated or in another sequence. For instance, some of the stages may be performed concurrently, in part or in whole, may be skipped, or may be performed in different orders, e.g., stage (A) may be performed after stage (B).

As illustrated in system 100, a user 104 may seek to access a particular webpage using a client device 106. The user 104 may be, for example, a developer of a webpage seeking to access a webpage, a user seeking to access information from the webpage, and an administrator seeking to validate a configuration of the webpage. The user 104 may communicate with the system 100 through their respective client device 106. The client device 106 may include a personal computer, a workstation, a handheld device, a portable table, a smart phone, or any other type of device capable of communicating over a network to the server 114. The client device 106 may communicate with the server 114 over the network 102 using any form of communication protocol, e.g., Hypertext Transfer Protocol (HTTP) or Transport Layer Security (TLS).

In some examples, the client device 106 may execute a web-based application or a native application that provides an interactive interface to the user 104. In some examples, the client device 106 may communicate with the server 114 over a network 102 through one or more application programmable interfaces (APIs), for example, to request a webpage, retrieve configuration information, or perform another request. The one or more APIs may enable a single webpage interaction as well as bulk or batched webpage requests.

In some implementations, the client device 106 may present a graphical user interface (GUI) that enables the user 104 to transmit a request 105 to the server 114 for a particular webpage. The GUI on the client device 106 may enable the user 104 to provide certain details related to the request 105, which provide the one or more parameters of the webpage to be requested. For example, the request 105 may specify a webpage through one or more of the following: user 104 inserting uniform resource locator (URL) for the webpage, user 104 selecting a GUI element on the interface of the client device 106 for the webpage, and, user 104 interacting with another element on the interface of the client device 106 for the webpage. In some cases, the GUI on the interface of the client device 106 may allow the user 104 to include one or more parameters that identify a webpage and optionally provide one or more parameters for providing hints to identify the webpage, such as accessing a webpage in preview mode, for example.

The client device 106 may generate a request 105 according to the indication provided by the user 104. The request 105 may include, for example, user attributes 108, device attributes 110, and a page request 112. The user attributes 108 may include, for example, a session identifier, a user identifier, geolocational data of the user 104, username and password of the user 104 for authenticating with the server 114, and other information that identifies the user 104. The device attributes 110 may include, for example, an internet protocol (IP) address of the client device 106, a media access control (MAC) address of the client device 106, network characteristics utilized by the client device 106, operating system of the client device 106, and communication protocols used by the client device 106, to name some examples. The page request 112 may include, for example, a URL path, a webpage identifier, a key that identifies a webpage, an indicator corresponding to a GUI interaction that identifies a webpage, or other identifiers.

In some implementations, the request 105 may include implicit information. For example, the implicit information may include identifiers of the user 104 or identifiers of the client device 106 included in the header information of the request 105. In some cases, the request 105 may be encrypted or encoded depending on the communication protocol established between the client device 106 and the server 114.

During stage (A), the client device 106 transmits the request 105 over the network 102 to the server 114. The server 114 may receive the request 105 over the network 102. In response to receiving the request 105, the server 114 may initiate the processes of analyzing the request to determine the type of webpage being requested, the type of trained machine learning model to select, and data outputs to be performed and produced. In some implementations, the server 114 may queue the request 105 for processing in a distributed task manager that allocates webpage request tasks. The server 114 may perform website request tasks for a variety of client devices. As a result, the server 114 may validate the request 105 to determine that the request 105 was submitted in the proper format, with the proper parameters, and that the data included in the request 105 matches the expected schema.

In some implementations, the server 114 may receive the request 105 and parse the received request 105. In particular, the server 114 may extract the user attributes 108, the device attributes 110, and the page request 112. In some cases, the server 114 may perform additional verification checks to standardize the data provided in the received request 105. The server 114 may generate a record according to the received request and store the record in memory with a time stamp. For example, the server 114 may recognize from the received request 105 the webpage being requested using the information included in the page request 112 and may identifying the user 104 and the corresponding client device 106 that submitted the request 105 using the user attributes 108 and the device attributes 110, accordingly. In some cases, if the server 114 determines that various information is missing from the received request 105, then server 114 may fill in the various missing information using default information and logs the missing information with the record in memory.

During stage (B), the server 114 may use the page request 116 to retrieve the configuration for the requested webpage and retrieve the one or more corresponding webpage variants 118. The configuration may be stored in a database, such as an internal database, data store, external system, like database 111. In some cases, the database 111 may store each webpage variant as indexed by a page identifier. The page identifier may include, for example, a page ID, a URL, a key, or another form of identifying a webpage.

Each webpage variant of the set of webpage variants 118 stored in the database 111 may include various information. Each webpage variant may include, for example, a variant identifier, a status identifier indicating whether the webpage is actively being displayed or is inactive, eligibility rules associated with a device for displaying and audience constraint, metadata associated with percentages of how often this webpage variant is selected, layout metadata describing identifiers, content, structure, and schema versions of the corresponding webpage, and the goal metrics 126 for the corresponding webpage.

In some implementations, the goal metrics 126 may define the desired action or actions that a developer or site designer intends a user to perform on that webpage and how those actions are measured. For example, the actions may include selecting a specified GUI element, e.g., a “Purchase” button, transitioning from the current page to a designated subsequent page, reaching a scroll depth or section by scrolling, submitting a form, a zooming action on the webpage, and other conversion or engagement actions to be performed.

Each goal metric 126 may additionally store information related to the execution of the desired action or actions. This information may include, for example, (i) an event type, (ii) a window time corresponding to when the action is to be performed, e.g., within a current session or within a set time, and (iii) a counting identifier indicating an occurrence for this action being performed. The goal metrics 126 may be defined for each webpage or defined across a subset of webpages or each of the webpage variants. Multiple goal metrics may be defined per webpage, such as a primary conversion target and a secondary conversion target, and a composite conversion for multiple actions to be performed. In some cases, the server 114 may store these goal metrics 126 along with the variant configuration for each webpage variant 124 in the database 111.

In some implementations, the server 114 may select a subset of the webpage variants from the webpage variants 124. The server 114 may filter the webpage variants 124 for webpage variants that fit the criteria of the specific request 105. In some examples, the server 114 may select the webpage variants from the webpage variants 124 using the page identifier from the page request 112. In some examples, the server 114 may further filter the selected webpage variants using the user attributes 108 and the device attributes 110. For example, if one or more of the selected webpage variants are set to a mobile device layout when the client device 106 is a desktop, the server 114 may filter those webpage variants from the selected webpage variants. In another example, if one or more of the selected webpage variants involve a high network bandwidth and the network bandwidth between the client device 106 and the server 114 does not satisfy a bandwidth amount, then those selected webpage variants may be filtered from the selected webpage variants.

In some cases, the server 114 may filter the selected webpage variants using the user attributes 108. If the server 114 determines that certain users, as defined by the user attributes 108, are unable to view certain webpage variants or certain webpages due to restrictions or lack of authorization, then the server 114 may remove those corresponding webpage variants from the selected webpage variants. The result of the filtering of webpage variants 124 is the selected webpage variants 132 that are eligible for the specific request 105, together with each webpage variant's goal definition or metric. If the server 114 determines that no webpage variants 124 satisfy the request 105, then the server 114 may select a default version of webpage variants and record the lack of webpage variants in memory.

During stage (C), the server 114 may select a trained machine learning model 134 from the group of trained machine learning models 128. In some implementations, the server 114 may utilize the user attributes 108 to select the trained machine learning model 134 to utilize for making the prediction. The server 114 may generate an index from the user attributes 108 to use for identifying the trained machine learning model 134. The server 114 may generate the index by retrieving a personal identifier from the user attributes 108, such as a username of the user 104, a password submitted by the user 104, or another user identifier associated with the user 104. The personal identifier may correspond to an alphanumerical number, for example, that uniquely identifies user 104 to the server 114. In some cases, the server 114 may use the personal identifier as the index. In some cases, the server 114 may encode the personal identifier to create the index. In some cases, the server 114 may execute a hash on the personal identifier to create the index.

In some implementations, the server 114 may correlate the index with a model identifier. The model identifier may be a number, a string of letters, or an alphanumerical string that identifies and acts as an index for a particular trained machine learning model in the database 111. The server 114 may retrieve the corresponding trained machine learning model 134 using the index and the corresponding model identifier.

Each trained machine learning model is associated with a particular user. For instance, each model is trained using data belonging to a particular individual or entity, such as a particular user. As a result, training data for different users or different entities are not mixed across different machine learning models. This training method ensures that model isolation is preserved and user privacy is maintained across different models. As a result of selecting the trained machine learning model 134 using the user attributes 108, the server 114 may expose an identifier and configuration of the trained machine learning model. The identifier may correspond to an address of the trained machine learning model. Each trained machine learning model has a common API interface that accepts the same input fields and outputs scores for each webpage variant. In some cases, if no trained machine learning model is selected from the group of trained machine learning models 128, then the server 114 may select a default trained machine learning model that is not yet tuned to the particular user 104. As a result, the common interface API is exposed to the trained machine learning model 134, which is ultimately used to score the webpage variants 132.

During stage (D), the server 114 prepares inputs for the selected trained machine learning model 134 and invokes the selected trained machine model 134 to score each of the selected webpage variants 132 according to the data provided in the request 105. The purpose here is for the selected trained machine learning model 134 to compute, for each candidate, a likelihood that the user 104 will perform the configured goal metric for the webpage 126 if this webpage is presented to the user 104 on the client device 106. In some cases, each webpage of the selected webpage variant 132 may include the same goal metric 126. In some cases, each webpage of the selected webpage variant 132 may include a different goal metric 126.

In some implementations, the server 114 may generate input for the selected trained machine learning model 134 using the user attributes 108, the device attributes 110, the goal metric for each webpage 126, and the selected webpage variants 132. Specifically, the server 114 may generate a data structure to use for the input to the selected trained machine learning model 134. The data structure may include, for example, a vector, a matrix, a protocol buffer, a JavaScript Object Notation (JSON) file, or another data type. The data structure may include, for example, a per-candidate list of the selected webpage variants 132 and their corresponding goal metrics 126. The data structure may additionally include descriptors of the user attributes 108 and the device attributes 110 that aid the selected trained machine learning model 134 from identifying the corresponding user 104 and client device 106 of the corresponding request 105.

In some implementations, a selected webpage variant from the variants 132 may include multiple goal metrics 126. In these cases, the multiple goal metrics 126 may include a primary conversion goal and a secondary conversion goal. These may include, for example, transitioning from a first page to a second page (primary conversion goal) and a secondary conversion goal of selecting a GUI element on the second page (secondary conversion goal). In order for the selected trained machine learning model 134 to identify which goal is currently being processed, whether both goals are being processed, or some other combination of goals, the server 114 may include a goal identifier the data structure. The goal identifier may include, for example, an identifier that indicates to the selected trained machine learning model 134 which goal is being evaluated or an indication that allows the selected trained machine learning model 134 to produce multiple goal specific scores. In the latter case, the selected trained machine learning model 134 may process the data and return a vector that includes a set of goals and a corresponding score for each goal.

In some implementations, prior to invoking the selected trained machine learning model 134, the server 114 verifies that the data structure conforms to the schema required by the model 134. In some cases, the server 114 may verify that any missing values are replaced with default values and inappropriate values are replaced by other values. In response to verifying and/or conforming the correctness of the data structure as inputs, the server 114 may provide the data structure as input to the selected trained machine learning model 134. The selected trained machine learning model 134 may process the selected webpage variants 132 along with the other inputs to generate a score or likelihood that the user 104 will perform the goal or target action for each selected webpage variant.

During stage (E), the server 114 receives the likelihood scores produced in stage (D) for each of the selected webpage variants 132 and selects the webpage variant 132 for the request 105. The server 114's selection of the webpage variant 132 is based on the likelihood score. For example, the server 114 compares each webpage variant's likelihood score to a threshold value. If the server 114 determines that one or more of the output webpage variants satisfies the threshold value, e.g., meets or exceeds the threshold value, then the server 114 selects the webpage variant with the highest score among those that satisfy the threshold value. If none of the output webpage variants'likelihood scores satisfy the threshold value, then the server 114 may select the highest scores webpage variant. In some examples, the server 114 may select a default webpage variant for the requested webpage if none of the output webpage variants'likelihood scores satisfies the threshold value.

As illustrated in system 100 of example FIG. 1, the selected trained machine learning model 134 outputs a webpage variant 136 with a likelihood score of 95%, webpage 138 with a likelihood score of 25%, and a webpage with a likelihood score of 55%. The server 114 compares each of these scores to a threshold value of 55%, for example. Since webpage variants 136 and 134 satisfy the threshold value, then the server 114 selects the webpage variant 136 as the webpage variant 136 to satisfy the request 105. In response, the server 114 stores the recorded webpage variant 136 along with the request 105 and other information in memory for logging and tracking purposes.

After selecting the webpage variant 136, the server 114 executes generation of the GUI data for the webpage variant 136. The generation of the GUI data for the webpage variant 136 includes generation of Hypertext Markup Language (HTML) data, JAVA data, or data related to a server-side rendering for display on the client device 106. The GUI data for the webpage variant 136 may be stored in memory for quicker request and retrieval later for subsequent requests by client device 106 or other client devices.

During stage (F), the server 114 transmits the GUI data 140 for the selected webpage to the client device 106 over the network 102. In some cases, the GUI data 140 may be compressed and encrypted according to an established protocol between the server 114 and the client device 106. Upon the client device 106's receipt of the GUI data 140, the client device 106 may parse the received GUI data 140 and render the GUI data for display of the selected webpage variant 136. The selected webpage variant 136 is then displayed on the client device 106.

After the GUI data 140 for the selected webpage variant 136 is delivered to the client device, the client device 106 provides feedback data to the server 114. For example, if the user 104 performs the corresponding goal metric 126 for the corresponding selected webpage variant 132, then this feedback data is provided to the server 114. The server 114 records a positive result for the served selected webpage 136 and the selected trained machine learning model 134. Alternatively, if the goal metric 126 is not completed, such as the user does not perform the designated button click or page transition, for example, then the server 114 records a negative result for the served selected webpage 136 and the selected trained machine learning model 134.

In some implementations, the server 114 may use the positive and negative results for affirming and retraining the selected trained machine learning model 134, respectively, and reevaluating the selected trained machine learning model 134. In some cases, the data associated with the negative and positive results are used to the selected machine learning model 134 to ensure that the model is updated while preserving data privacy and not training the other models.

In some implementations, the system provides an automated ML pipeline for continuous learning, model refreshing, and deployment of updated models without manual intervention. The ML pipeline may enhance the responsiveness of a website optimization system by shortening the time between observed user behavior on a webpage and model updates that influence selection of one or more webpages. The server 114 may execute the processes of the ML pipeline, for example.

In some implementations, the automated ML pipeline system is fully automated for both training and deployment. Each model of the ML pipeline or policy of models may specify its own training and deployment cadence and configuration via configuration files. A workflow scheduler, for example, may manage the building, scheduling, and monitoring of workflows or jobs related to the ML pipeline.

In some implementations, the ML pipeline obtains both streaming events, e.g., page views, button clicks, and goal completions, and mini-batch training. Raw inputs are passed through data validation and privacy filters. The system may derive model features, e.g., user/device attributes, webpage variant descriptions, and goal labels, and publish the model features to be stored for consistent use across training and inference.

In some implementations, the ML pipeline may integrate hybrid training to efficiently process large volumes of data and update models in near real time. A streaming training may update models or model components at short intervals to react quickly to shifts in variant performance, while a mini-batch trainer periodically retrains on longer windows of historical data to stabilize estimates. Integration occurs at the policy level, where the system may combine or weight model outputs, with the policies set through configuration files.

In some implementations, the ML pipeline may employ implemental training. The implemental training may update model parameters using only new or modified data, which beneficially reduce computational load and deployment latency. The trainer may adjust the learning rates and apply exponential decay to historical data so more recent data trends receive greater weight than less recent trends. This approach avoids retraining the entire model from scratch while still adapting the model to various new data and patterns.

In some implementations, the ML pipeline may include an offline model replay system that accelerates model iteration and evaluation without impacting live traffic systems. The system replays historical user interactions through a candidate model as if that model has been active at the historical time, using stored data. The ML pipeline computes policy metrics, such as Area Under the ROC Curve (AUC) or F1 scores, but also goal attainment and other metrics to determine whether a candidate model should advance to online testing. Model decisions may then be evaluated to determine one or more options for performing online testing.

In some implementations, once the models are trained, the models are synchronized to different serving machines. For example, the serving system may be provided by TensorFlow serving on Amazon Web Service (AWS) Elastic Container Service (ECS), among others. The ML pipeline may promote models according to their cadence and ensures the models are required for inference.

The automated ML pipeline system may advantageously provide for personalization models to remain current with evolving user behaviors, while providing timely and relevant website experiences. Online replay may further improve the success rate of later online test by pre-evaluating model choices without affecting later online tests.

In some implementations, the server 114 may provide a policy experimentation framework with an override mechanism to improve model selection, comparison, and control within ML-based website optimization systems. This framework supports, for example, a dual random number method for controlled experimentation, a rule-based override capability, and a flexible experimentation configuration.

In some implementations, the dual random number method includes both an intra-policy and inter-policy comparison. In the intra-policy model selection, a first random number selects models within a single policy for comparison or supplementations. In the inter-policy comparison, a second random number provides for comparisons between different policies, which allows for a robust experimental analysis. In either arrangement, the mapping from random numbers to chosen policy and/or model is consistent, so that a given user is mapped to the same model or policy over time.

In some implementations, the override mechanism includes rule-based decision adjustments that allows predefined rules to adjust or override model outputs during serving. The override mechanism supports compliance and governance by enforcing business logic, legal regulations, and ethical standards during automated decisions. In some implementations, the override mechanism may include a flexible experimentation configuration for supporting configurations where the first random number is skipped to implement a mixture of expert systems. The system may also adjust weighting or selection behavior without departing from the dual number random structure.

In some implementations, the policy experimentation framework system may provide continuous model updates, with new models designed to review and improve upon existing model iterations. The model experimentation framework facilitates comparisons between different models in a real time environment. In addition to individual models, the production system may employ policies, including groups of models working together. The experimentation framework may support comparisons between policies to formulate the problem using a dual random number method whether the first random number controls which policy to choose and the second random number which model to choose. The mapping from random number to model/policy is consistent so that a single user may be mapped to the same model or policy each time.

In some implementations, the intra-policy model selection does not have to rely on the random number. For mixtures of expert models where there is a router to combine different submodels, the test intra policy may be ignored or given little weight while still supporting the inter-policy comparisons.

In some implementations, the system may provide manual override of the traffic allocations over ML models. This is desirable in cases such as model failures and/or customers having strong opinions about traffic allocation for certain events. The framework's override mechanism enables these manual controls while maintaining the surrounding experimental structure. As a result, the combination of the policy experimentation framework with override increases the precision and flexibility of model and policy comparison and provides control over automated decisions to balance ML benefits with policy decisions. This framework and may be performed by the server 114, for example.

In some implementations, the server 114 may provide an artificial intelligence (AI) powered insights capability that applies large language models (LLMs) to analyze experimental results and to interact with customer queries to produce actionable insights and recommendations. The AI-powered insights system includes an integrated analysis of experimentation data, conversational interactions with context, and proactive generation of follow-up insights.

In some cases, the integrated data analysis combines experimentation data with user inquiries to provide customized insights to the user. The AI-powered system may provide conversations interactions that support multi-turn interactions with context awareness to provide coherent and relevant responses to user inquiries. The system may extract experiment statistics, synthesize those statistics in the context of webpage optimization, and presents results in the form that is accessible and actionable to users.

In some implementations, the AI-powered insights system may operate as a chatbot. The chatbot may support multi-turn conversations with context awareness. The system may begin a conversation by presenting several common questions that a user may ask, e.g., “What are the overall insights?” A user may select one of the presented questions or submit a free form question. The system may store the conversation sequence and uses that stored conversation sequence to generate coherent and relevant responses. The system may proactively suggest follow up questions and provide additional analysis to deepen a user's understanding. A response from the chatbot may include, for example, multiple suggested options presented in the user interface for selection. The system may also generate further questions or analyses based on the user's prior selections and queries.

In some implementations, the AI-powered insight tool is linked to one or more assisted APIs of an LLM with function call capabilities. The system can, in response to a user query, trigger querying of an internal database, extract variation performance parameters or other experiment data and analyze the statistics using customized prompts to interpret the statistics. The system may maintain a dialog thread, receive user inputs, and collect user feedback or user actions, such as a thumbs up or a thumbs down.

In some implementations, the LLM may compose a response that reflects the retrieved statistics and the active conversation. The system may summarize log data into variation parameters that are aligned with customer defined metrics. In response to a user submitting related inquires, the LLM models may trigger a function call to acquire related information implemented based on the user queries. Additionally, the system may evaluate responses using both the LLM evaluator and the human feedback. For example, the system may compare the evaluator's judgments with user feedback to iteratively improve prompts to narrow the gap between the evaluations by the LLM based evaluator and user feedback preferences.

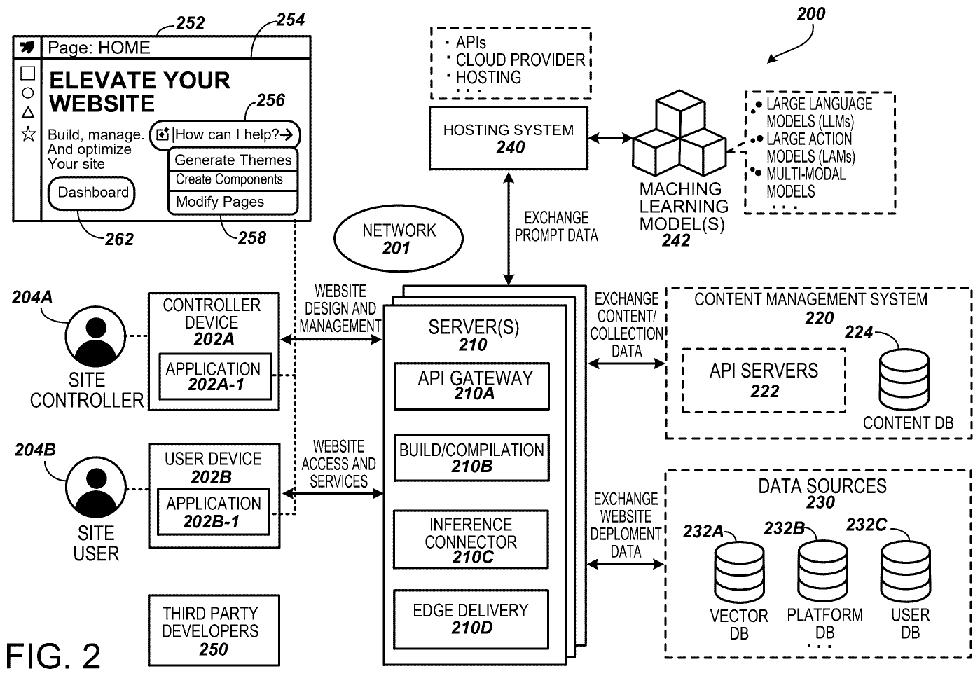

FIG. 2 illustrates an example of a web experience platform (WEP) 200 for enabling website development. In general, the website development capabilities enable users to design digital experiences, ingest user-defined digital experience specifications, transform the user-defined digital experience specifications into deployable artifacts, and distribute resulting web experiences over a network. For example, the WEP 200 may receive design-time input that specifies pages, components, styles, interactions, and content, compile or otherwise process that input (e.g., assistance from one or more ML models) into executable markup, code bundles, media, and metadata. The WEP 200 may store intermediate and final artifacts in multi-tenant data stores, identify published experience and associated application services to site visitors with edge-based delivery resources. This environment may further support content management, e-commerce, membership gating, localization, extension APIs, among other types of functionality.

In general, system 200 leverages ML within a content-management, schema-constrained WEP to address computer-centric problems in generating, selecting, and rendering webpage modifications at scale. System 200 obtains structured inputs defined by a content schema and associated metadata (e.g., section-level or hierarchy information), constructs constrained prompt data or model inputs from those structures, and applies trained ML models to produce candidate outputs that are validated for structural compatibility before use in the build and delivery pipeline. By grounding ML operations in machine-readable constraints and executing only schema-compatible results, system 200 improves computer operation in distributed web systems (e.g., by reducing integration failures, avoiding incompatible markup, limiting unnecessary network transfers, and enabling low-latency rendering of a single, selected variant on the client device). The WEP further augments and/or improves various aspects of the web development functionality through use of one or more ML models 242. These ML models 242 may be invoked at multiple, independent junctures of WEP workflows to streamline, accelerate, and/or augment tasks that have traditionally needed manual development effort.

For example, a site controller operating the controller device 202A may access an ML interface 256 (e.g., presented as a text-chat, voice, or multimodal panel within the existing design canvas) to submit natural language prompts that cause the one or more ML models 242 to generate entire page layouts, reusable components, helper functions, and the corresponding markup or code artefacts without leaving an authoring environment. After a site has been deployed, other ML interfaces may be used to request automated regeneration or modification of components in a manner that preserves data bindings and collection schemas maintained by a content management system (CMS) 220. This reduces the risk of breaking existing CMS-driven pages.

In another example, a site controller 204A or site user 204B administrator may invoke an ML assistant exposed through a dashboard widget to obtain step-by-step guidance on operational tasks (e.g., configuring localization variants, setting up gated-membership rules, or troubleshooting performance settings) based on conversational queries rather than navigating multiple configuration panels. Each of these interfaces may simply route prompt data to external model resources (e.g., hosting system 240) and returns model output to the same front-end context, the ML functionality may be layered onto different phases of the website-development lifecycle without requiring structural changes to the underlying build, orchestration, or delivery services.

The WEP 200 includes various computing and data elements, examples of which are shown in FIG. 2. These elements generally exchange data over a network 201. A controller device 202A represents an authoring endpoint operated by a site controller. A user device 202B represents a consumption endpoint operated by a site user. Additional third-party developer devices 250 may interact with extension tooling.

One or more servers 210 enable centralized functionality associated with the WEP 200. The one or more servers 210 may correspond to the server 114 shown in FIG. 1. As such, the server 114 may perform the functionality described with respect to the one or more servers 210. Servers 210 further include API gateways 210A, orchestration modules 210B, build/compilation modules 210C, inference connector modules 210D, and edge-delivery modules 210D, each of which cooperate to perform request handling, background workflow, artifact generation, machine-learning integration, and content deliver network (CDN)-style dissemination, respectively. CMS 220 encloses API servers 222 and a content database 224. Further, data sources 230 includes persistent stores, such as vector database 232A, platform database 232B, user DB 232C. A hosting system 240 exchanges prompt data and model output with one or more ML models 242.

In more detail, the site controller 204A may operate a controller device 202A (e.g., desktop computer, laptop, tablet, or similarly capable computing terminal). The controller device 202A executes an authoring application 202A-1 that communicates with WEP 200 over network 201. Using the authoring application 202A-1, the site controller may generate, import, or modify design-time assets (e.g., page structures, component libraries, style sheets, interaction timelines, and data bindings) and submit corresponding save, build, or publish requests to the servers 210. Controller device 202A may render the authoring application in a browser context, a native container, or another runtime environment, and may exchange design-and-or-maintain website-deployment data with the platform in real time or near-real time.

A site user 204B may operate a user device 202B (e.g., desktop computer, laptop, tablet, smartphone, set-top box) executing a runtime application 202B-1 that requests and renders published site assets delivered by the servers 210. The user device 202B may load static pages, dynamic CMS-backed content, e-commerce flows, membership-gated resources, or localized variants, depending on how the site was configured by the controller. Interactions initiated from the user device 202B may result in access-and-or-interact website-deployment data being exchanged with the servers 210, with optional personalization, authentication, or analytics processing performed along the way.

As shown in FIG. 2, the authoring application 202A-1 presents a designer interface 252 that provides access to visual tools enabling a site controller 204A to construct and/or alter a page 254 without direct manipulation of source code. Within interface 252 a component pane may surface reusable elements such as component 262, and a canvas or viewport may preview the evolving layout in real time. An ML interface 256 permits the site controller 204A to issue natural language prompts or other inputs to interact with the one or more models 242 via hosting system 240. Interface 256 may be implemented in various ways, such as a chat panel, voice overlay, multimodal widget, among others. Responsive model output may drive ML-assisted functions 258, which may include, for example, automatically generating page sections, refactoring existing component 262 for accessibility or localization, producing CMS-compatible schema suggestions, or inserting client-side logic templates. Depending on configuration, similar ML interfaces may also surface within runtime application 202B-1, allowing site users to obtain guided assistance or perform management tasks through conversational interaction.

One or more servers 210 operate as the execution core of WEP 200, receiving network traffic from external actor devices, coordinating internal workflows, invoking machine-learning resources, and emitting deployable or runtime assets. Although depicted as a single logical block, servers 210 may be implemented as a co-located cluster, a distributed micro-service mesh, or a cloud-hosted arrangement that scales elastically with demand.

The servers 210 incorporate a set of software modules configured to cooperate through message queues, RPC calls, or other service-bus mechanisms. API gateway modules 210A handle synchronous ingress. An orchestration tier (not shown in FIG. 2) manages background or long-running tasks. Build/compilation modules 210B convert design input into deployable artifacts. An inference connector layer 210C broker prompt exchanges with the hosting system 240. Edge delivery modules 210D stage static and dynamic resources for low-latency distribution. Each module may be containerized, serverless, or otherwise independently deployable, allowing updates to be rolled out without interrupting the WEP 200.

API gateway modules 210A perform various functions, such as terminating Transport Layer Security (TLS), validating JavaScript Object Notation (JSON) Web Tokens, and expose Representative State Transfer (REST), Graphical Query Language (GraphQL), or WebSocket interfaces that client applications call when saving designs, fetching CMS content, or running administrative queries. They may apply per-workspace or per-site rate limits, translate external resource identifiers into internal shard keys, and inject correlation metadata into each request for downstream tracing. In zero-trust configurations, the API gateway modules 210A may also perform mutual-TLS handshakes with edge nodes or developer command line interfaces (CLIs) before forwarding traffic onto the internal mesh.

Build/compilation modules 210B retrieve development snapshots, CMS bindings, and theme settings, then emit hashed asset bundles, pre-optimized image variants, framework-specific component libraries, and search-index manifests. A dependency graph may be used to identify pages or assets are invalidated by a change so that a full rebuild is avoided. Unchanged artifacts may also be linked from previous build versions. Output objects are written to a versioned bucket (e.g., Amazon Simple Storage Service (S3)), tagged with a content hash and build-number metadata, and handed off to edge-delivery modules for global propagation.

Inference connector modules 210C assemble prompt payloads that may include design fragments, content snippets, schema fingerprints, and user-authored questions. The inference connector modules 210C may sign each request with a per-workspace API key, apply temperature or max-token policies set by workspace administrators, and/or dispatch prompts to an external model endpoint over authenticated (e.g., HTTP/2) channels. Inference connector modules 210C also parse received model output into typed actions, such as “generate component,” “rewrite copy,” or “suggest accessibility fix.” These parsed outputs may be queued back to orchestration modules or streamed directly to user devices.

Edge delivery modules 210D take artifacts produced by the build/compilation modules 210B and replicate them across geographically distributed points of presence. Assets may be version-pinned so a canary rollout may serve the new build to a percentage of traffic while the prior build remains active for the remainder. Edge workers may also execute JavaScript or WebAssembly to perform request-time tasks (e.g., cookie-based A/B routing, on-the-fly image resizing, or server-side rendering of personalized fragments before returning a response that is cached for subsequent requests).

The architecture of the servers 210 enable various applications of ML models 242 in relation to different web development workflows accessible through the WEP 200. In some implementations, the servers 210 enable an authoring workflow in which a newly added component is propagated from the design canvas to production in near real-time. For example, when a controller drags a “testimonial” component onto the canvas, the interface 252 emits a JSON delta via WebSocket to API-gateway modules 210A. Orchestration modules enqueue a build job, and the build/compilation modules 210B regenerate only the affected page bundle while reusing shared CSS and runtime libraries. Inference connector modules 210C send the component copy to ML models 242 (e.g., LLM) and requests tone-consistent rewrites. Model output data is then streamed back to the interface 252 for user review and approval. The edge delivery modules 210D pre-warm caches for the updated path, enabling publishing to be completed quickly (e.g., under a second).

In some implementations, the servers 210 enable a live component-refactor workflow that automates accessibility or structural updates across an existing site. A site controller 204A may type “convert nav bars to an accessible drop-down” into ML interface 256. In response, inference connector modules 210C package a prompt containing the site's navigation markup and audit results, retrieve refactored HTML and a, and forward the patch to build-and-compilation modules 210B. After incremental compilation, edge-delivery modules 210D push the new build while invalidating only nav-bar assets. A rollback pointer to the previous build is retained for instant reversion if post-publish tests fail.

In some implementations, the servers 210 enable an administrative guidance workflow that delivers conversational, ML-generated instructions for platform configuration tasks. For example, a site user 204B may interact with a voice widget to ask, “How do I enable multi-language support?” In this example, a voice clip may be transcribed on the user device 202B and posted to API-gateway modules 210A. Inference connector modules 210C query one or more ML models 242 (e.g., knowledge base aware model) that returns a checklist of localization steps plus one-click mutation calls. Orchestration modules then create a location workspace, build/compilation modules 210B obtain locale variants, and edge delivery modules 210D begin serving Accept-Language aware routes. This workflow allows the task to be completed without manual navigation through multiple settings screens.

CMS 120 manages structured content that populates pages, components, and dynamic lists served by WEP 200. The system lets a site controller define collections, fields, and localized variants, then stores and surfaces that content so that build and runtime processes may merge it with design artifacts. During machine learning workflows prompts may be enriched with relevant collection entries or schema information. Model output may be validated against the same schema to ensure that any generated markup stays coordinated with stored data.

CMS 220 further includes API servers 222 and content database 224. The API servers 222 expose read and write endpoints that the design canvas, build pipeline, and runtime site all consume. The content database 224 stores collection items, draft, locale variants, and reference links (e.g., in a multi-tenant partition so that different workspaces remain isolated). These elements of CMS 220 let other modules in WEP 200 (e.g., modules of servers 210) treat content as a typed data source rather than raw text.

API servers 222 may implement REST and GraphQL methods for creating collections, uploading media, managing localization, and querying entries at build or request time. Requests enter through API gateway modules 210A and are routed to the appropriate microservice shard. Each call is checked against workspace roles so that only authorized users or processes may insert or mutate content. The servers 210 also transmit events that orchestration modules may listen to in order to trigger incremental rebuilds or cache purges.

Content database 224 is a multi-region document store that persists collection schemas, field values, slug indexes, and locale mappings. Each write operation may be versioned, allowing rollback if a site controller 204A accidentally deletes or changes an entry. The content database 224 supports full-text and faceted search so that runtime pages may query on reference fields without loading entire collections. It also stores media metadata that edge delivery modules 210D may use for responsive image selection.

Interaction between API servers 222 and content database 224 may follow a strict commit path. For example, API servers 222 validate incoming payloads against collection schemas, transform the payloads into storage records, and write them to content database 224 in a transaction that ensures referential integrity. When data changes the servers publish a change event to orchestration modules. Build/compilation modules 210B may pull the updated entries, regenerate only the affected pages, and write new artifacts to the build repository. Edge delivery modules 210D receive a signed cache bust instruction so that users see the updated content without delay. This communication loop ensures design, content, and deployment states are aligned even when machine learning models generate or modify content through the same APIs.

Data sources 230 provide a storage layer that underpins content retrieval, machine learning context, and runtime personalization for WEP 200. Databases included in the database sources 230 may sit outside the servers 210 so it may scale storage capacity independently of compute demand. For example, read and write operations flow through API gateway 210A or orchestration tasks, and change events propagate to build or edge services so that newly stored records appear in published sites without manual intervention. During prompt generation, the inference connector 210C enriches requests with context fetched from these stores, and after model inference, the same stores are updated or queried to confirm that generated output aligns with existing schemas.

Vector database 232A stores high-dimensional embeddings that represent component code snippets, CMS entries, design tokens, and knowledge base documents. The vector database 232A supports approximate nearest-neighbor search so the inference connector may retrieve semantically similar records in milliseconds. Embeddings are regenerated during build or on demand when a large batch of content changes. The store also tracks embedding versions so model prompts always receive context that matches the active design or content revision.

Platform database 232B holds project metadata such as workspace settings, build history, billing status, feature flags, and role assignments. Each workspace or site occupies a logical partition that isolates records while still allowing cross-workspace queries for administrative analytics. The database maintains foreign keys to build artifacts in object storage and to content items in CMS 220, which lets server modules assemble a complete view of a project without performing fan-out requests.

User database 232C records site member accounts, authentication tokens, membership tiers, and e-commerce order history. Access tokens generated by API gateway 210A map to rows in this store, allowing edge delivery modules 210D to evaluate gating rules during request processing. The user database 232C also captures engagement metrics such as last login time or page view counts, which may feed personalization or analytics dashboards.

The databases discussed above operate together through shared identifiers and event streams to maintain consistency across the platform. When a controller publishes a new collection item the CMS writes the entry to content database 224 and emits an event that triggers embedding generation in vector database 232A. The same event updates index pointers in platform database 232B so build modules may link the new content to its deployment record. If the item is member-restricted, a policy pointer is stored in user database 232C so edge delivery modules may enforce access at request time. This coordinated flow ensures that machine learning prompts receive up-to-date context, model output respects schema constraints, and published pages honor all access and personalization rules.

Hosting system 240 provides a managed inference service that receives prompt data from server modules and returns machine generated output used to augment website design, build, and runtime tasks. The hosting system 240 may allocate compute resources, schedule model workloads, enforce request quotas, and logs usage metrics. Prompt requests may include design fragments, CMS records, or visitor questions. Response payloads may contain generated code snippets, rewritten copy, layout suggestions, or operational guidance that the platform may apply without manual intervention.

Hosting system 240 integrates with the WEP 200 through a set of network accessible endpoints that may be reached by direct API calls, by cloud provider private links, or by a customer managed hosting arrangement. The inference connector 210C authenticates each request with an API key, signs payloads, and posts them to an endpoint path that selects a specific model or model version. The hosting system 240 may reside in a public cloud region, in a dedicated tenancy, or in an on-premise cluster that meets data residency requirements. Configuration flags allow workspace administrators to choose among these connectivity modes without changing application code.

Machine learning models 242 implement the inference logic that generates the information used by the WEP 200. The models may be large language models (LLMs) that excel at natural language generation, large action models (LAMs) that plan multi step tasks, or multimodal (MM) models that accept and emit combinations of text, code, or image embeddings. Each model may be versioned and measured for token usage, latency, and accuracy. The hosting system 240 may route traffic to a single model or to an ensemble of models depending on the prompt type and workspace policy.

Machine learning models 242 operate inside the hosting system 240 in containerized runtimes, e.g., runtimes that that expose uniform gRPC and REST interfaces. The hosting layer may handle model loading, weights decryption, warm-up sequences, and autoscaling. It also injects guardrail middleware that checks prompts for policy compliance and truncates or redacts disallowed content. Model output is streamed back to WEP 200 in an event format that preserves token order so the authoring canvas may display partial completions in real time.

As discussed above, the WEP 200 may be designed in various implementations to augment, improve, or streamline various aspects of website development using interactions with the one or more ML models 242. For example, a site controller 204A may access interface 252 on controller device 202A and enter a natural language prompt into ML interface 256 asking the platform to “generate a five-page marketing site for a coffee brand with warm colors and bold headings.” Application 202A-1 then sends the prompt to API gateway modules 210A over network 201. Inference connector modules 210C forward the prompt to hosting system 240 which relays it to machine learning models 242. The ML models 242 return structured markup and component definitions that reference images and copy aligned with the request. Build/compilation modules 210B merge the generated markup with schema information pulled from content database 224 through API servers 222 so that every collection reference is valid. Edge delivery modules 210D publish the new artifacts and invalidate only the changed routes which lets user devices 202B immediately load the freshly created pages.

As another example, a site controller 204A may decide to localize the site for Spanish speaking visitors using the same workflow. The site controller 204A issues a prompt in interface 256 that requests translated versions of each collection item stored in content management system 220. API gateway modules 210A receive the prompt along with collection identifiers. Inference connector modules 210C assemble context by fetching the English records and related embeddings from vector database 232A then pass that context to machine learning models 242. The ML models 242 return translated field values which API servers 222 write as new locale variants in content database 224 while platform database 232B records a build dependency for each updated item. Build/compilation modules 210B regenerate only the localized bundles and edge delivery modules 210D tag them with Accept-Language rules so site users automatically receive the correct language version.

In yet another example, during ongoing operation a site user 204B signs in through application 202B-1 and asks an on-page chatbot how to schedule a product launch for next Friday. The question travels through network 201 to API gateway modules 210A and is passed to inference connector modules 210C with user context from user database 232C. Machine learning models 242 analyze the prompt and return a step list that includes creating a draft collection item, assigning a release date, and triggering a publish event. The response also contains signed mutation requests that API servers 222 may execute on behalf of the authenticated user. Orchestration logic writes the new item to content database 224, schedules a timed build in platform database 232B, and notifies build and compilation modules 210B to pre render the page. Edge delivery modules 210D queue a cache purge for the launch path so the new content appears exactly when the scheduled date arrives.

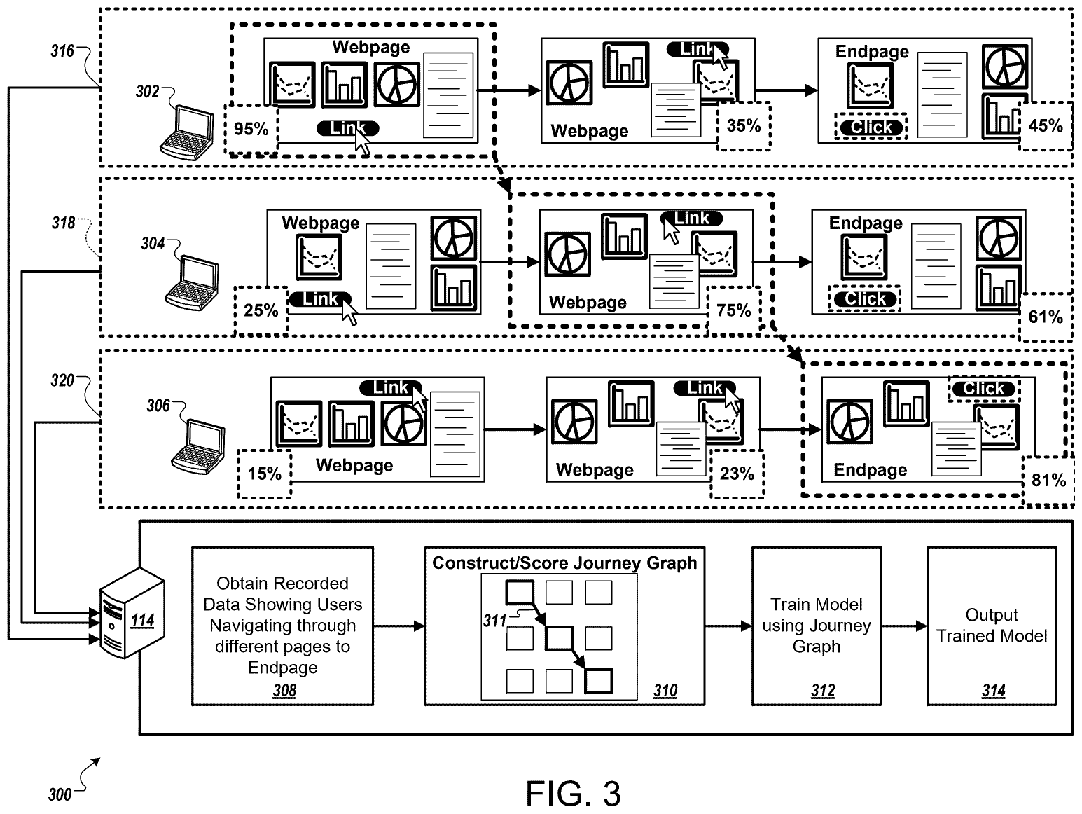

FIG. 3 is a block diagram of a system 300 for dynamically constructing a user journey graph to achieve a target objective. The system 300 includes one of more functions that are performed by the server 114. The processes described in system 300 may be beneficial for when a particular webpage variant or multiple webpage variants include a multi-goal process.

In some implementations, the server 114 may perform a method for determining a full user journey across multiple webpages by constructing a dynamic user journey graph and selecting user behavior at each step to achieve specific goals. A dynamic journey graph models the entire user experience to identify key interaction points with one or more webpages, rather than treating outcomes as isolated events. Sequential behavior for a user's interaction with a webpage at each step is applied to the graph to guide users toward desired outcomes. In addition, or alternatively, hierarchical multi-objective behavior analysis may be applied so objectives at local, sitewide, and downstream levels are considered simultaneously. By focusing on the entire user journey rather than isolated end goals, this technique provides a comprehensive strategy to enhance user experience and conversion rates across the website including one or more pages.

In some implementations, constructing a dynamic user journey graph may include formulating viewed webpages and aggregated transitions between pages as a directed graph. In the directed graph, each node is a webpage and each edge between webpage represents a transition probability. This journey graph, generated by the server 114, is dynamic in at least two respects: edges are probabilistic and estimated according to observed traffic and the journey group is time variant. Based on configurations of goals, reaching different nodes/webpages of the graph may yield different rewards and/or values. In some implementations, if a node is deemed to have a high transition probability, the nodes'neighbors are also deemed to have a high value.

In some implementations, the server 114 executes a propagation method to calculate the value of each graph node. The propagation method may include, for example, backward value propagation or another type of propagation, to calculate a value for each node that reflects the expected likelihood of reaching an end page or target action from the particular node. User behavior is then analyzed by promoting webpage variants that lead viewers from the current page to a higher valued next page. In some aspects of developing the model, the server 114 may evaluate graph node values by examining the conversion events on high value pages. In some cases, the server 114 may sample the high value page URLs and manually examine those pages to validate or determine their importance.

As illustrated in system 300, the server 114 may observe navigation across webpages of the same website. For example, the server 114 may observe navigation across multiple client devices, e.g., client devices 302, 304, and 306, each of which produces a session instance. Client device 302 produces a session trace 316; client device 304 produces a session trace 318; and client device 306 produces a session trace 320. In these session traces, a user navigates across various pages of the same website. Each event, such as clicking on page, zooming in on a page, transitioning between webpages, is time stamped and recorded by the server 114 in memory for tracking purposes.

At 308, the server 114 obtains recorded navigation data showing users moving through webpages. This navigation data may include, for example, the navigation through each webpage in each of the session traces, actions performed by each user to navigate through the webpages, timestamps for performing the actions, and actions indicative of arrival at the end page or end goal for the particular webpage.

At 310, the server 114 generates a user journey graph using the obtained navigation data from each of the instances 316, 318, and 320. The server 114 estimates transition probabilities on edges between each of the webpages. As illustrated in system 300, the transition probabilities in instance 316 illustrate a transition probability to the first webpage of 95%, a transition probability from the first webpage to the second webpage as 35%, and a transition probability from the second webpage to the third webpage as 45%. The server 114 estimates the same probabilities for each of the nodes in the instances 318 and 320.

Afterward, the server 114 may estimate goal nodes for each of the nodes navigated across the instances 316, 318, and 320. Then, across each node, the server 114 may estimate and rank candidate next pages by expected progress towards a desired goal. In a hierarchical multi-objective configuration, the server 114 performs a scoring step and may output a group of scoring values for each node or each webpage. As a result, the server 114 generates a candidate path 311 as the path with the highest candidate next pages.

At 312, the server 114 may train a machine learning model using features derived from the user journey graph with various context. In particular, the server 114 may trained the machine learning model using the candidate path 311 with various context that includes, current webpage information, candidate next webpage information, transition probabilities, node values, user attributes associated with the client devices, and client device attributes. The purpose for training the machine learning model is to target the probability of recommending next candidate webpage variants or to reach a desired goal. The machine learning model is trained until the model may sufficiently output a user journey graph for a series of webpages.

At 314, the server 114 may deploy the trained machine learning model at inference. In some cases, the server 114 invokes the trained machine learning model when a request is received for a particular webpage. The server 114 retrieves a current user journey graph and retrieves graph derived features for the user's current webpage. The graph derived features may include, for example, one or more candidate webpages, transition probabilities, among other. The server 114 generates an input data structure that includes the graph derived features, the user attributes, the device attributes, and the goal metric for the webpage. The server 114 provides the input data structure to the trained machine learning model.

The trained machine learning model outputs a likelihood of scores for each of the candidate webpages and the candidate webpage variants for the current webpage. The server 114 then selects the webpage or webpage variant with the highest likelihood score that is expected to progress the user towards the desired goal. Depending on how the user actually proceeds through the webpage, the server 114 may refresh or update the current user journey graph and to retrain the machine learning model.

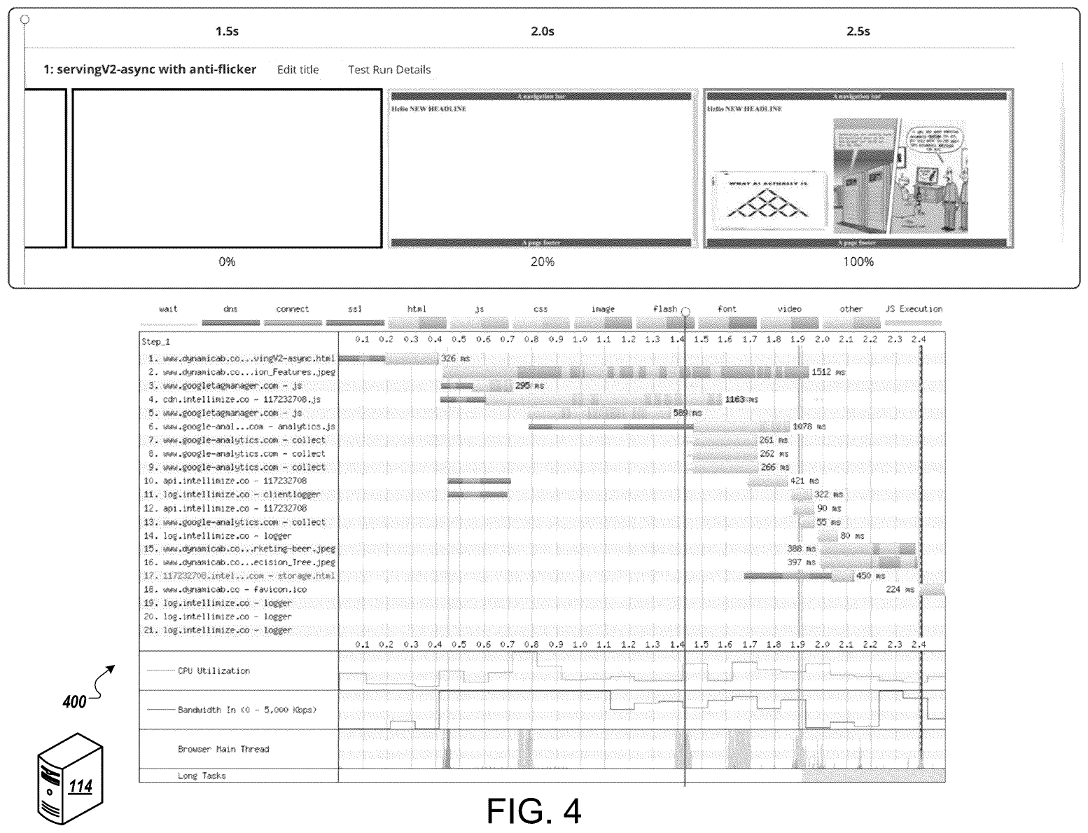

FIG. 4 is a block diagram of various user interfaces 400 that illustrate an anti-flicker system for rendering of webpage variations. Server 114 of FIG. 1 generate and provide the user interfaces 400 to one or more client devices.

In some implementations, the server 114 may execute an anti-flicker system for a client-side rendering of webpage variations that minimizes flicker and improve the user's visual experience. The server 114 executes the anti-flicker system by initially hiding the entire webpage for a configurable period before the asynchronous snippet downloads the client programs. Once the client code is fully loaded and begins executing, the webpage or hidden portions of the webpage are revealed at the client device 106. In some implementations, various regions on the client device are hidden until the regions are ready. This prevents partial or incomplete renderings from being shown. In some implementations, the client may apply variations to the Document Object Model (DOM) in each frame immediately before the browser renders to provide smooth, flicker-free updates.

In some cases, when a base page is loaded on a client device, the browser begins to draw any webpage currently available, or a base version of the webpage. If the server 114 selects a webpage variant to show after the first draw, the client device replaces parts of the webpage with the chosen webpage version. The user sees the webpage change in front of them, such as in a quick flash or a so called “flicker.” The flicker may be perceived as jumpy to the user and may impede a user's engagement.

In some cases, the server 114 may quickly fix this flicker issue by blocking the page until the webpage variant choice is ready. This action may stop the flicker, but the blocking of the webpage leaves the user staring at a screen, such as a white screen, and makes the website appear slow. The opposite approach is to let the browser on the client device to load a website freely and decide later when to update the webpage variant. This alternative approach keeps the page feeling fast at first, but then the client device swaps in the new webpage variant, which causes the very flicker the server 114 desires to avoid.

In some implementations, the server 114 may perform a variety of techniques to prevent perceptive flicker at the client device when presenting a selected webpage variant to the client device. In some cases, the server may allow the browser to download assets on the base page in parallel to loading the webpage variations, rather than prior solutions of loading the variations synchronously, which may delay the rendering of the webpage for the end users. At the same time or substantially the same time, the server 114 may instruct the client device 106 to temporarily hide only those regions of the webpage that are expected to change. In parallel, the server 114 may determine the selected webpage variant for the request to display on the client device.

In some implementations, a web browser on a client device renders web pages by requesting assets from various server-side systems. The browser may build an in-memory representation of the page called a Document Object Model (DOM) for a webpage. The browser may use the DOM to progressively render those assets on the screen so the assets are visible to the end user. DOM updates may include, for example, inserting, removing, or removing sections; modifying attributes of a webpage; changing text content of the webpage; and, adding, removing, or resizing elements. In some implementations, the client device 106 may apply the DOM updates before a paint operation so that the affected regions are updated.

When the selected webpage variant is available, the client device 106 applies the update to the DOM just before the next paint operation and then the client device 106 removes the temporary hiding regions so those regions appear in their final state. If the selection is then not available by a particular deadline, for example, the client device 106 may reveal the base content and suppress any swap before a particular action is performed by the user and prevent a visible flicker.

In some implementations, the server 114 may accelerate the loading of webpages by providing resource hints to the client device to prevent flicker. The resource hints include preload and pre-connect directives that are configured for cross-origin access as needed to minimize excessive HTTP requests and parallelizes establishing web server connections.

In some implementations, the anti-flicker technique may operate entirely on the client device without the use of the server 114. In some implementations, the anti-flicker technique may operate in a hybrid mode with the server 114 renders GUI data when the client fates certain regions to avoid flicker. The system may monitor the page speed and visual stability metrics and may tune various parameters to ensure that flicker is minimized or eliminated while keeping page loading fast.

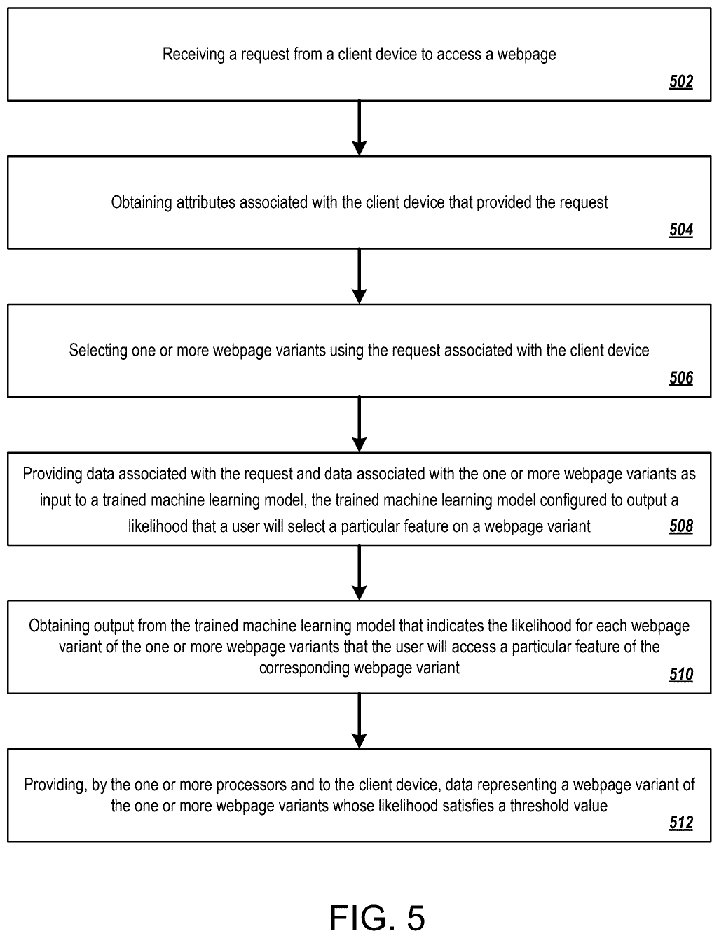

FIG. 5 is a flow chart illustrating an example method 500 of determining a webpage variant using machine learning. The server 114 of FIG. 1 may perform the processes associated with method 500, for example.

During 502, the server can receive a request from a client device to access a webpage. The request may include user attributes, device attributes, and a page request. A user can transmit the request to the server from the client device.

During 504, the server can obtain attributes associated with the client device that provided the request. Specifically, the server can obtain user attributes associated with the user that interacts with the client device to provide the request. The server can obtain device attributes associated with the client device that provides the request. The server can select a trained machine learning model from a plurality of trained machine learning models using the user attributes associated with the user that interacts with the client device. Each trained machine learning model is associated with a different user.

During 506, the server can select one or more webpage variants using the request associated with the client device. The server can obtain an identifier of the webpage from the received request. The server can select the one or more webpage variants using the obtained identifier of the webpage. The one or more webpage variants include different graphical representations of the webpage in the request.

During 508, the server can provide data associated with the request and data associated with the one or more webpage variants as input to a trained machine learning model, the trained machine learning model configured to output a likelihood that a user will select a particular feature on a webpage variant. Here, the server can obtain inputs to provide to the trained machine learning model and the inputs include user attributes associated with the user that provided the request, device attributes associated with the client device that submitted the request, a goal metric associated with the one or more selected webpage variants, and the one or more selected webpage variants. The server can provide these obtained inputs to the trained machine learning model.

The trained machine learning model is configured to output a likelihood that a user will select a particular feature on a webpage variant. In particular, the server can obtain the goal metric associated with each of the one or more selected webpage variants. The goal metric includes a desired event for a user to perform on a webpage variant. Moreover, the goal metric associated with the one or more selected webpage variants includes at least one of a selection a graphical user interface (GUI) button on the webpage, transitioning from the webpage to a subsequent webpage, or performing another action on the webpage.

During 510, the server can obtain output from the trained machine learning model that indicates the likelihood for each webpage variant of the one or more webpage variants that the user will access a particular feature of the corresponding webpage variant. In some implementations, obtaining output from the trained machine learning model that indicates the likelihood for each webpage variant of the one or more webpage variants that the user will access a particular feature of the corresponding webpage variant includes the server obtaining the likelihood for each webpage variant of the one or more webpage variants that the user will perform the desired event associated with the goal metric. The server can compare the likelihood for each webpage variant of the one or more webpage variants to the threshold value and select the webpage variant whose likelihood satisfies the threshold value.

During 510, the server can provide, to the client device, data representing a webpage variant of the one or more webpage variants whose likelihood satisfies a threshold value. This includes the server generating GUI data that represents the webpage variant whose likelihood satisfies the threshold value. The server can provide the generated GUI data that represents the webpage variant to the client device for display. Additionally, the server providing the data representing the webpage variant of the one or more webpage variants whose likelihood satisfies a threshold value includes the sever dynamically adjusting traffic to the client device associated with the webpage variant according to one or more goal metrics.

This specification uses the term “configured” in connection with systems and computer program components. For a system of one or more computers to be configured to perform particular operations or actions means that the system has installed thereon software, firmware, hardware, or a combination thereof that, in operation, cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification may be realized in digital electronic circuitry, in tangibly embodied computer software or firmware, in computer hardware, including the structures disclosed in this specification and their structural equivalents, or in combinations of one or more of them. Implementations of the subject matter described in this specification may be implemented as one or more computer programs (e.g., one or more modules of computer program instructions) encoded on a tangible non-transitory storage medium for execution by, or to control the operation of, data processing apparatus. The computer storage medium may be a machine-readable storage device, a machine-readable storage substrate, a random or serial access memory device, or a combination of one or more of them. The program instructions may be encoded on an artificially generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus may also be, or further include special purpose logic circuitry (e.g., an FPGA (field programmable gate array) or an ASIC (application-specific integrated circuit)). The apparatus may optionally include, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, may be written in any form of programming language, including compiled or interpreted languages, or declarative or procedural languages; and it may be deployed in any form, including as a stand-alone program or as a module, component, subroutine, or other unit suitable for use in a computing environment. A program may, but need not, correspond to a file in a file system. A program may be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in some cases, multiple engines may be installed and running on the same computer or computers.

The processes and logic flows described in this specification may be performed by one or more programmable computers executing one or more computer programs to perform functions by operating on input data and generating output. The processes and logic flows may also be performed by special purpose logic circuitry (e.g., an FPGA, an ASIC), or by a combination of special purpose logic circuitry and one or more programmed computers.

Computers suitable for the execution of a computer program may be based on general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. The central processing unit and the memory may be supplemented by, or incorporated in, special purpose logic circuitry. Generally, a computer will also include or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media, and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification may be provisioned on a computer having a display device (e.g., a CRT (cathode ray tube) or LCD (liquid crystal display) monitor) for displaying information to the user and a keyboard and a pointing device (e.g., a mouse, a trackball), by which the user may provide input to the computer. Other kinds of devices may be used to provide for interaction with a user as well; for example, feedback provided to the user may be any form of sensory feedback (e.g., visual feedback, auditory feedback, tactile feedback); and input from the user may be received in any form, including acoustic, speech, or tactile input. In addition, a computer may interact with a user by sending documents to and receiving documents from a device that is used by the user; for example, by sending web pages to a web browser on a user's device in response to requests received from the web browser. Also, a computer may interact with a user by sending text messages or other forms of message to a personal device (e.g., a smartphone that is running a messaging application), and receiving responsive messages from the user in return.

Data processing apparatus for implementing machine learning models may also include, for example, special-purpose hardware accelerator units for processing common and compute-intensive parts of machine learning training or production (e.g., inference, workloads).

Machine learning models may be implemented and deployed using a machine learning framework (e.g., a TensorFlow framework, a Microsoft Cognitive Toolkit framework, an Apache Singa framework, an Apache MXNet framework).

Implementations of the subject matter described in this specification may be realized in a computing system that includes a back-end component (e.g., as a data server) a middleware component (e.g., an application server), and/or a front-end component (e.g., a client computer having a graphical user interface, a web browser, or an app through which a user may interact with implementations of the subject matter described in this specification), or any combination of one or more such back-end, middleware, or front-end components. The components of the system may be interconnected by any form or medium of digital data communication (e.g., a communication network). Examples of communication networks include a local area network (LAN) and a wide area network (WAN) (e.g., the Internet).

The computing system may include clients and servers. A client and server are generally remote from each other and typically interact through a communication network. The relationship between client and server arises by virtue of computer programs running on the respective computers and having a client-server relationship with each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) may be received at the server from the device.

While this specification contains specific implementation details, these should not be construed as limitations on the scope of any invention or on the scope of what may be claimed, but rather as descriptions of features that may be specific to particular implementations of particular inventions. Certain features that are described in this specification in the context of separate implementations may also be implemented in combination with a single implementation. Conversely, various features that are described in the context of a single implementation may also be implemented in multiple implementations separately or in any suitable sub-combination. Moreover, although features may be described above as acting in certain combinations and even initially be claimed as such, one or more features from a claimed combination may in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems may generally be integrated together into a single software product or packaged into multiple software products.

Particular implementations of the subject matter have been described. Other implementations are within the scope of the following claims. For example, the actions recited in the claims may be performed in a different order and still achieve desirable results. As one example, the processes depicted in the accompanying figures do not necessarily require the particular order shown, or sequential order, to achieve desirable results. In some cases, multitasking and parallel processing may be advantageous.

A number of implementations have been described. Nevertheless, it will be understood that various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method comprising:
receiving, by one or more processors, a request from a client device to access a webpage;
obtaining, by the one or more processors, attributes associated with the client device that provided the request;
selecting, by the one or more processors, one or more webpage variants using the request associated with the client device;
providing, by the one or more processors, data associated with the request and data associated with the one or more webpage variants as input to a trained machine learning model, the trained machine learning model configured to output a likelihood that a user will select a particular feature on a webpage variant;
obtaining, by the one or more processors, output from the trained machine learning model that indicates the likelihood for each webpage variant of the one or more webpage variants that the user will access a particular feature of the corresponding webpage variant; and
providing, by the one or more processors and to the client device, data representing a webpage variant of the one or more webpage variants whose likelihood satisfies a threshold value.

2. The computer-implemented method of claim 1, wherein obtaining attributes associated with the client device that provided the request comprises:
obtaining, by the one or more processors, user attributes associated with a user that interacts with the client device to provide the request; and
obtaining, by the one or more processors, device attributes associated with the client device that provides the request.

3. The computer-implemented method of claim 2, further comprising selecting, by the one or more processors, a trained machine learning model from a plurality of trained machine learning models using the user attributes associated with the user that interacts with the client device, wherein each trained machine learning model is associated with a different user.

4. The computer-implemented method of claim 1, wherein selecting one or more webpage variants using the request associated with the client device comprises:
obtaining, by the one or more processors, an identifier of the webpage from the received request; and
selecting, by the one or more processors, the one or more webpage variants using the obtained identifier of the webpage, wherein the one or more webpage variants comprise different graphical representations of the webpage in the request.

5. The computer-implemented method of claim 1, wherein providing data associated with the request and data associated with the one or more webpage variants as input to a trained machine learning model comprises:
obtaining, by the one or more processors, inputs to provide to the trained machine learning model, wherein the inputs comprise user attributes associated with the user that provided the request, device attributes associated with the client device that submitted the request, a goal metric associated with the one or more selected webpage variants, and the one or more selected webpage variants; and
providing, by the one or more processors, the obtained inputs to the trained machine learning model.

6. The computer-implemented method of claim 5, wherein the trained machine learning model configured to output a likelihood that a user will select a particular feature on a webpage variant comprises obtaining, by the one or more processors, the goal metric associated with each of the one or more selected webpage variants, wherein the goal metric comprises a desired event for a user to perform on a webpage variant.

7. The computer-implemented method of claim 6, wherein the goal metric associated with the one or more selected webpage variants comprises at least one of a selection a graphical user interface (GUI) button on the webpage, transitioning from the webpage to a subsequent webpage, or performing another action on the webpage.

8. The computer-implemented method of claim 7, wherein obtaining output from the trained machine learning model that indicates the likelihood for each webpage variant of the one or more webpage variants that the user will access a particular feature of the corresponding webpage variant comprises:
obtaining, by the one or more processors, the likelihood for each webpage variant of the one or more webpage variants that the user will perform the desired event associated with the goal metric;
comparing, by the one or more processors, the likelihood for each webpage variant of the one or more webpage variants to the threshold value; and
selecting, by the one or more processors, the webpage variant whose likelihood satisfies the threshold value.

9. The computer-implemented method of claim 1, wherein providing, by the one or more processors and to the client device, data representing the webpage variant of the one or more webpage variants whose likelihood satisfies a threshold value comprises:
generating, by the one or more processors, GUI data that represents the webpage variant whose likelihood satisfies the threshold value; and
providing, by the one or more processors, the generated GUI data that represents the webpage variant to the client device for display.

10. The computer-implemented method of claim 1, wherein providing, by the one or more processors and to the client device, data representing the webpage variant of the one or more webpage variants whose likelihood satisfies a threshold value comprises dynamically adjusting traffic to the client device associated with the webpage variant according to one or more goal metrics.

11. A system comprising:
one or more computers; and
one or more storage devices storing instructions that are operable, when executed by the one or more computers, to cause the one or more computers to perform operations comprising:
receiving, by one or more processors, a request from a client device to access a webpage;
obtaining, by the one or more processors, attributes associated with the client device that provided the request;
selecting, by the one or more processors, one or more webpage variants using the request associated with the client device;
providing, by the one or more processors, data associated with the request and data associated with the one or more webpage variants as input to a trained machine learning model, the trained machine learning model configured to output a likelihood that a user will select a particular feature on a webpage variant;
obtaining, by the one or more processors, output from the trained machine learning model that indicates the likelihood for each webpage variant of the one or more webpage variants that the user will access a particular feature of the corresponding webpage variant; and
providing, by the one or more processors and to the client device, data representing a webpage variant of the one or more webpage variants whose likelihood satisfies a threshold value.

12. The system of claim 11, wherein obtaining attributes associated with the client device that provided the request comprises:
obtaining, by the one or more processors, user attributes associated with a user that interacts with the client device to provide the request; and
obtaining, by the one or more processors, device attributes associated with the client device that provides the request.

13. The system of claim 12, further comprising selecting, by the one or more processors, a trained machine learning model from a plurality of trained machine learning models using the user attributes associated with the user that interacts with the client device, wherein each trained machine learning model is associated with a different user.

14. The system of claim 11, wherein selecting one or more webpage variants using the request associated with the client device comprises:
obtaining, by the one or more processors, an identifier of the webpage from the received request; and
selecting, by the one or more processors, the one or more webpage variants using the obtained identifier of the webpage, wherein the one or more webpage variants comprise different graphical representations of the webpage in the request.

15. The system of claim 11, wherein providing data associated with the request and data associated with the one or more webpage variants as input to a trained machine learning model comprises:
obtaining, by the one or more processors, inputs to provide to the trained machine learning model, wherein the inputs comprise user attributes associated with the user that provided the request, device attributes associated with the client device that submitted the request, a goal metric associated with the one or more selected webpage variants, and the one or more selected webpage variants; and
providing, by the one or more processors, the obtained inputs to the trained machine learning model.

16. The system of claim 15, wherein the trained machine learning model configured to output a likelihood that a user will select a particular feature on a webpage variant comprises obtaining, by the one or more processors, the goal metric associated with each of the one or more selected webpage variants, wherein the goal metric comprises a desired event for a user to perform on a webpage variant.

17. The system of claim 16, wherein the goal metric associated with the one or more selected webpage variants comprises at least one of a selection a graphical user interface (GUI) button on the webpage, transitioning from the webpage to a subsequent webpage, or performing another action on the webpage.

18. The system of claim 17, wherein obtaining output from the trained machine learning model that indicates the likelihood for each webpage variant of the one or more webpage variants that the user will access a particular feature of the corresponding webpage variant comprises:
obtaining, by the one or more processors, the likelihood for each webpage variant of the one or more webpage variants that the user will perform the desired event associated with the goal metric;
comparing, by the one or more processors, the likelihood for each webpage variant of the one or more webpage variants to the threshold value; and
selecting, by the one or more processors, the webpage variant whose likelihood satisfies the threshold value.

19. The system of claim 11, wherein providing, by the one or more processors and to the client device, data representing the webpage variant of the one or more webpage variants whose likelihood satisfies a threshold value comprises:
generating, by the one or more processors, GUI data that represents the webpage variant whose likelihood satisfies the threshold value; and
providing, by the one or more processors, the generated GUI data that represents the webpage variant to the client device for display.

20. One or more non-transitory computer-readable media storing software comprising instructions executable by one or more computers which, upon such execution, cause the one or more computers to perform operations comprising:
receiving, by one or more processors, a request from a client device to access a webpage;
obtaining, by the one or more processors, attributes associated with the client device that provided the request;
selecting, by the one or more processors, one or more webpage variants using the request associated with the client device;
providing, by the one or more processors, data associated with the request and data associated with the one or more webpage variants as input to a trained machine learning model, the trained machine learning model configured to output a likelihood that a user will select a particular feature on a webpage variant;
obtaining, by the one or more processors, output from the trained machine learning model that indicates the likelihood for each webpage variant of the one or more webpage variants that the user will access a particular feature of the corresponding webpage variant; and
providing, by the one or more processors and to the client device, data representing a webpage variant of the one or more webpage variants whose likelihood satisfies a threshold value.
